(19) United States
(12) Patent Application Publication
(10) Pub. No.: US 2005/0034539 A1
(43) Pub. Date: Feb. 17, 2005

(54) Motor torque variation compensation

(76) Inventors: LeeLing Tan, Singapore (SG); MingZhong Ding, Singapore (SG); KianKeong Ooi, Singapore (SG); JianYi Wang, Singapore (SG)

Correspondence Address: Derek J.Berger,Seagate Technology LLC;Intelectual Property -COL2LGL, 389 Disc Drive, Longmont, CO, 80503, US

(21) Appl. No.: 10/814,016

(22) Filed: Mar. 31, 2004

Related U.S. Application Data
(60) Provisional application No. 60/494,976, filed on Aug. 14, 2003.

(51) Int. Cl. H02P 5/34

(52) U.S. Cl. 73/862.08

(57) ABSTRACT

Method and apparatus for compensating variations in motor torque in a control system that employs a motor to accelerate a control object, such as a data transducing head in a data storage device. During acceleration of the control object, a plurality of distances successively traveled by the control object are measured, and the measured distances are combined to compensate for said variations in motor torque. Preferably, a constant control input is applied to accelerate the control object at a constant rate of acceleration less than a maximum rate of acceleration that can be obtained by the motor. A coarse adjustment routine is preferably applied to arrive at a first compensation value that compensates for said variations at a first resolution, after which a fine adjustment routine is performed using the first compensation value to arrive at the final compensation value at a second resolution greater than the first resolution.

### RELATED APPLICATION

This application claims the benefit of U.S. Provisional Application Ser. No. 60/494,976, filed Aug. 14, 2003 under 35.U.S.C. 119 (e).

### FIELD OF THE INVENTION

This invention relates generally to the field of control systems and more particularly, but without limitation, to a method and apparatus for compensating for motor torque variations in a motor used to move a control object.

### BACKGROUND

Control objects are often positioned using closed loop control systems. Such systems feature a motor coupled to the control object and a closed loop feedback system which supplies inputs to position the control object as desired.

To provide the requisite stability, the feedback system should generally be designed to accurately reflect the actual response characteristics of the motor and the control object. While some characteristics remain essentially unchanged during operation (e.g., mass, resonant response, etc.), other characteristics may not. Specifically, motor torque (often expressed in terms of a “torque constant”) can vary over the operational movement range of the control object, depending upon the construct of the system.

By way of illustration, a data storage device often employs a rotary actuator that supports a data transducing head adjacent a recording medium (such as a magnetic disc). A coil of a voice coil motor (VCM) is affixed to the actuator, with the coil immersed in the magnetic field of a stationary magnetic circuit. A servo control loop applies current to the coil to rotate the actuator and hence, sweep the head across the medium surface.

In such a system, a reduction in VCM torque can be observed when the head is near the endpoints of the range of motion (e.g., adjacent the inner and outer diameters of the disc), due to a reduction in the magnetic field strength of the magnetic circuit at these locations.

While various approaches to compensating for variation in motor torque have been proposed, there nevertheless remains a continued need for improvements in the art, and it is to such improvements that the present invention is generally directed.

### SUMMARY OF THE INVENTION

In accordance with preferred embodiments, an apparatus and method are provided for compensating for variations in motor torque in a control system that employs a motor to accelerate a control object, such as a data transducing head in a data storage device.

In one aspect, the method generally comprises using the motor to accelerate the control object, and measuring a plurality of distances successively traveled by the control object during said acceleration to compensate for variation in motor torque.

Preferably, a constant control input is applied to accelerate the control object at a constant rate of acceleration less than a maximum rate of acceleration that can be obtained by the motor. Moreover, the control object is preferably maintained in a substantially fixed position to determine and compensate a magnitude of the bias force upon the control object prior to acceleration of the motor. These steps tend to reduce the effects of bias forces upon the measurements obtained.

Preferably, a final compensation value (denoted herein as the value “K_{A}”) is determined by performing a coarse adjustment routine to arrive at a first compensation value that compensates for said variations in motor torque at a first resolution. A fine adjustment routine is then performed using the first compensation value to arrive at the final compensation value at a second resolution greater than the first resolution.

In another aspect, the apparatus comprises a compensation circuit which measures a plurality of distances successively traveled by a control object during acceleration of said object by a motor to compensate for variation in motor torque.

The apparatus further preferably comprises a control circuit which applies an input to the motor to accelerate the control object, and wherein the compensation circuit determines a compensation value which is used by the control circuit to subsequently accelerate the control object.

As before, the motor preferably accelerates the control object at a constant rate of acceleration less than a maximum rate of acceleration that can be obtained by the motor. The control object is preferably maintained in a substantially fixed position to determine and compensate a magnitude of bias force upon the control object prior to acceleration of the motor. A coarse adjustment routine is preferably performed followed by a fine adjustment routine to obtain the final compensation value.

These and various other features and advantages which characterize the claimed invention will be apparent from a reading of the following detailed description and a review of the associated drawings.

### BRIEF DESCRIPTION OF THE DRAWINGS

FIG. 1 is a top plan view of a data storage device constructed and operated in accordance with preferred embodiments of the present invention.

FIG. 2 provides a functional block representation of a servo control loop of the device of FIG. 1.

FIG. 3 provides a functional block representation of a plant block of FIG. 2.

FIG. 4 graphically represents variations in motor torque provided by a voice coil motor (VCM) of the device of FIG. 1.

FIG. 5 is a graphical representation of an acceleration curve for a head of the device of FIG. 1.

FIG. 6 is a flow chart for a MOTOR TORQUE VARIATION COMPENSATION routine illustrative of steps carried out in accordance with preferred embodiments of the present invention.

### DETAILED DESCRIPTION

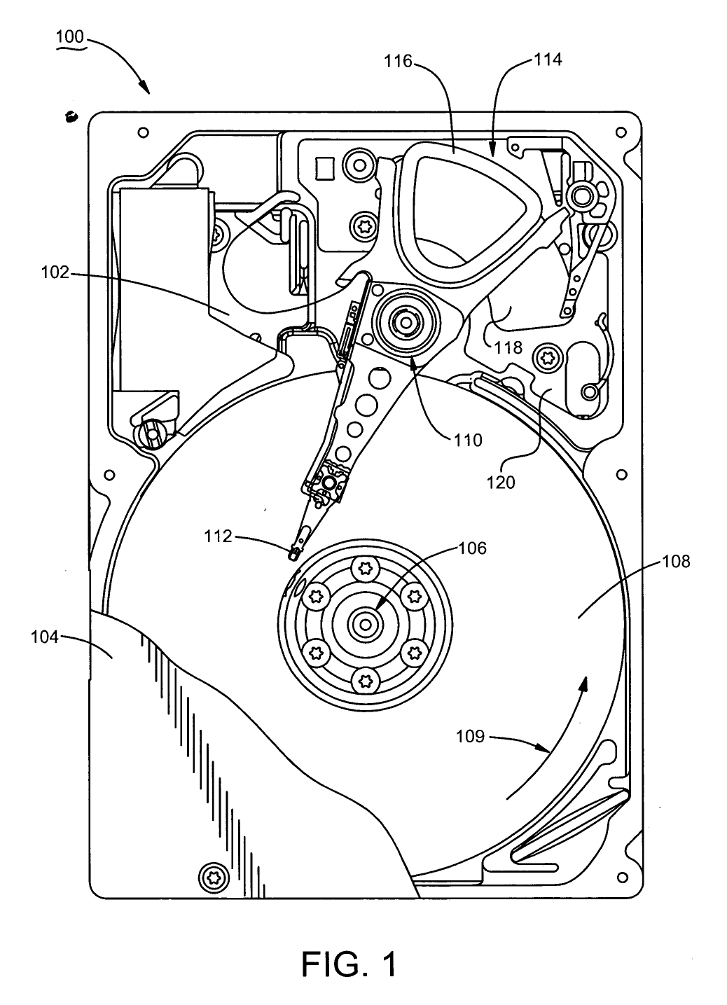

To provide an exemplary environment in which preferred embodiments of the present invention can be advantageously practiced, FIG. 1 shows a data storage device 100 configured to store and retrieve digital data. A base deck 102 cooperates with a top cover 104 (shown in partial cutaway) to form an environmentally controlled housing for the device 100.

A spindle motor 106 supported within the housing rotates a number of rigid magnetic recording discs 108 in a rotational direction 109. An actuator 110 supports a corresponding number of heads 112 adjacent tracks (not shown) defined on the disc surfaces. A voice coil motor (VCM) 114 is used to rotate the actuator 110 and hence, move the heads 112 radially across the discs 108.

The VCM 114 includes a moveable actuator coil 116 and a stationary magnetic circuit. The magnetic circuit includes a permanent magnet 118 supported on a magnetically permeable pole piece 120. A second pole piece and a second permanent magnet are normally disposed over the coil to complete the magnetic circuit, but these components have been omitted in FIG. 1 to provide a better view of the actuator coil 116.

Communication and control electronics for the device 100 are supported on a printed circuit board assembly (PCBA) mounted to the underside of the base deck 102 and hence, not visible in FIG. 1.

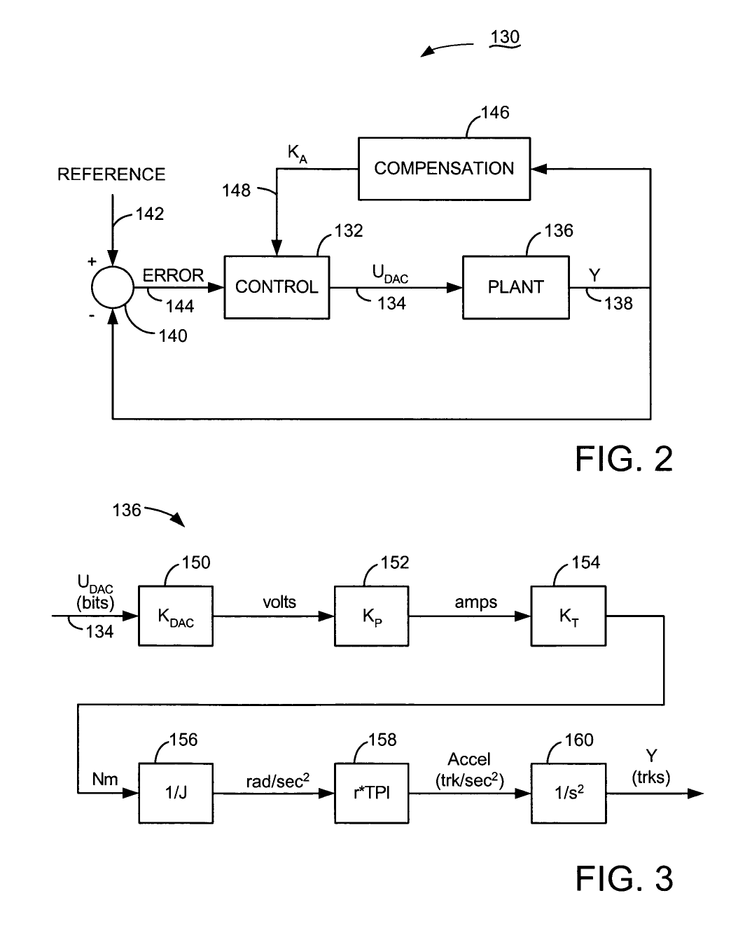

FIG. 2 provides a simplified representation of a servo control loop 130 of the device 100. A control circuit 132 outputs a current command value U_{DAC} on path 134 to a plant block 136. The plant block 136 is representative of certain electrical and mechanical aspects of the device 100 including the heads 112 and VCM 114 of FIG. 1.

An output of the plant block 136, Y, is representative of position of the selected head in response to the control input U_{DAC}. This output is supplied via path 138 to a summing junction 140. The summing junction 140 also receives an input reference position on path 142 indicative of the desired position for the head 112. The resulting output of the summing junction 140 constitutes an error signal which is provided as an input to the control circuit 132. In this way, closed loop head positional control is achieved.

The position Y is also supplied to a compensation circuit 146 which, as explained below, supplies a compensation value K_{A} to the control circuit 132 via path 148 to account for variations in VCM (motor) torque across the operational movement range of the actuator 110. It will be understood that the control circuit 132 and the compensation circuit 146 can be realized in hardware, in firmware executed by a programmable controller, or a combination thereof as desired.

FIG. 3 illustrates the transfer function response of the plant block 136 to describe the electro-mechanical conversion from input commanded current to output head position.

The input current command value U_{DAC} is a unitless, multi-bit digital value that is converted to a corresponding voltage by a digital to analog (DAC) converter 150 having a gain K_{DAC}. The output voltage from the DAC 150 is supplied to a gain block 152 representative of power amplifier gain K_{P}.

Block 154 represents torque constant K_{T} of the VCM and provides an output work value in Newton-meters (Nm). Block 156 models the actuator 110 with J representing the moment of inertia of the actuator mass. Block 158 is a conversion block with r corresponding to the radius of the head 112 and TPI the number of tracks per inch on the disc surface. Block 160 uses the Laplace operator s to convert acceleration to position, resulting in the aforementioned Y position output on path 138.

From FIG. 3, acceleration (“a”) of the head 112 can be described using the following relationship:

$$a = \frac{( {K}_{P} ) ( {K}_{T} ) ( {K}_{DAC} ) ( TPI ) ( {U}_{DAC} ) ( r )}{J} \qquad ( 1 )$$

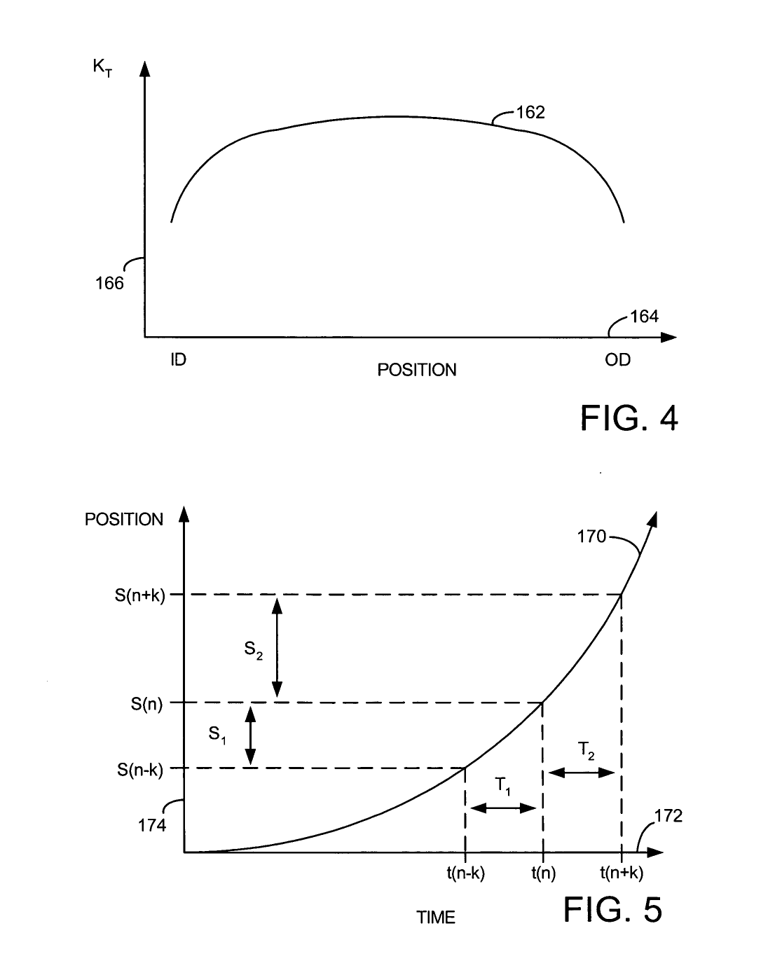

Generally, all of the various responses of the blocks in FIG. 3 remain constant except for the torque constant K_{T}, which tends to vary with head position such as shown in FIG. 4. More particularly, FIG. 4 provides a VCM torque curve 162 plotted against a position x-axis 164 representative of head position with respect to the associated disc surface and a y-axis 166 representative of motor torque amplitude.

The curve 162 shows that motor torque is substantially constant over a middle portion of the disc 108, but drops off as the head 112 approaches both the inner and outer diameters (ID and OD) of the disc 108. One factor that generally influences these variations in motor torque is a reduction in the magnetic flux density from the magnetic circuit of the VCM 114 near the edges of the permanent magnet 118.

Consistent actuator positioning across the full range of motion can be obtained by selecting the aforementioned compensation value K_{A} to mirror, and hence cancel out, the variation in the torque constant K_{T}. Equation (1) thus becomes:

$$a = \frac{( {K}_{P} ) ( {K}_{T} ) ( {K}_{DAC} ) ( TPI ) ( {U}_{DAC} ) ( r )}{J} ( {K}_{A} ) \qquad ( 2 )$$

The manner in which the compensation value K_{A} is preferably determined will now be described. FIG. 5 provides a graphical representation of an acceleration curve 170 which describes initial stages of acceleration of a selected head 112 by the servo loop 130 of FIG. 2 during a seek operation. The curve 170 is plotted against an elapsed time x-axis 172 and a position y-axis 174.

A time sampled system is contemplated using a time interval T_{S} so that the function t(T_{S}) represents elapsed time and the function S(T_{S}) represents movement distance. Along the x-axis 172, time samples t(n−k), t(n) and t(n+k) represent three successive times at the n−k^{th}, n^{th} and n+k^{th} samples (n and k are integers).

The value k may be equal to one, or equal to a higher value so that the three successive times on the x-axis 172 may or may not be abuttingly adjacent. That is, additional time samples (not denoted) may exist in the time interval T₁ between t(n−k) and t(n) and in the time interval T₂ between t(n) and t(n+k). T₁, of course, is nominally equal to T₂.

Along the y-axis 174, S(n−k), S(n) and S(n+k) represent the corresponding distances successively traveled by the head 112 at the three times t(n−k), t(n) and t(n+k). Because the head 112 is continuously accelerating, the distance interval S₂ between S(n) and S(n+k) is greater than the distance interval S₁ between S(n−k) and S(n).

A measured acceleration X_{MEAS} can be calculated from the measured distances S(n−k), S(n) and S(n+k) as follows:
X_{MEAS}=S(n+k)−2S(n)+S(n−k) (3)
The X_{MEAS} value represents acceleration of the head as measured using the Y output on path 138 in FIG. 2 in response to a selected U_{DAC} input to the plant 136. Preferably, the U_{DAC} input used to provide the curve 170 in FIG. 5 is a selected value that is maintained constant during the distance measurements so that nominally a constant rate of acceleration by the head 112 is obtained.

Moreover, the U_{DAC} input is preferably selected to be a mid-range value; that is, the U_{DAC} input magnitude is selected to be high enough to overcome the effects of any bias forces upon the head 112 (such as windage), while at the same time being well below the maximum current that can be supplied to the actuator coil 116 to minimize the effects of back electromagnetic force (bemf).

As explained in greater detail below, once the measured acceleration X_{MEAS} is obtained, this value is combined with a nominal acceleration X_{NOM} of the system. The X_{NOM} value is preferably obtained using the following relationship:

$${A}_{NOM} = \frac{( {K}_{P} ) ( {K}_{T} ) ( {K}_{DAC} ) ( TPI ) ( {U}_{DAC} ) ( r )}{J} ( 1 ) \qquad ( 4 )$$

It will be noted that equation (4) corresponds to equation (2) presented above, with the acceleration value “a” in equation (2) being identified as “A_{NOM}” in equation (4). Also, in equation (4) the compensation value K_{A} is given an initial value of one (this value is subsequently updated during the compensation process). The acceleration value A_{NOM} is converted to the time sample based acceleration value X_{NOM} as follows:
X_{NOM}=(A_{NOM})(k²)(T_{S}²) (5)

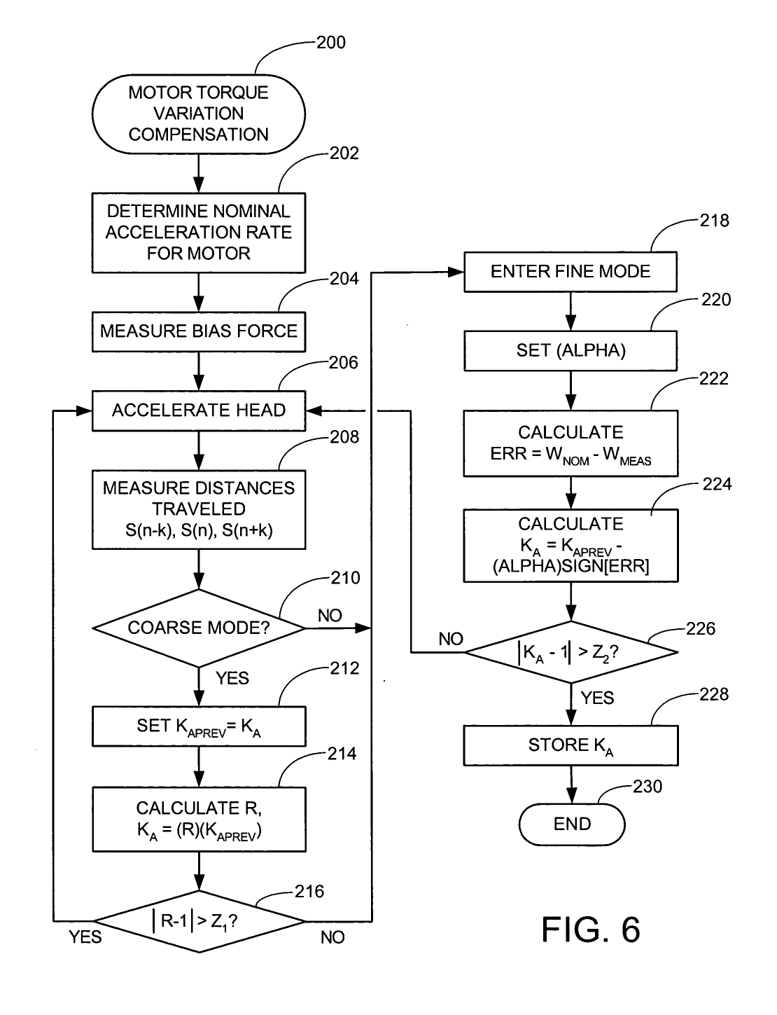

FIG. 6 provides a flow chart for a MOTOR TORQUE VARIATION COMPENSATION routine 200, generally illustrative of steps carried out in accordance with preferred embodiments of the present invention to compensate for variations in motor torque in the VCM 114. These steps are generally carried out by the control circuit 134 in conjunction with the compensation circuit 136 of FIG. 2.

At this point it will be appreciated that while the routine 200 will be discussed in terms of the servo loop 130, the routine is not so limited; rather, the routine more broadly describes a preferred manner in which motor torque compensation can be applied to any number of different types of control systems used to move control objects.

It will further be appreciated that the various steps in the routine 200 are preferably carried out in turn for each of a plurality of zones, or bands of tracks, across the disc surfaces. In this way, during subsequent operation the appropriate value of K_{A} can be loaded when the head 112 is in the associated zone. For simplicity of discussion, however, the routine 200 sets forth the calculation of a final compensation value for just one zone, and the routine can be repeated as necessary for additional zones.

Beginning at step 202, a nominal acceleration for the motor (in this case the VCM 114) is first determined. Preferably, this is carried out in accordance with equations (4) and (5) above to provide the value X_{NOM}.

At step 204, bias force on the head 112 is preferably measured by maintaining the head 112 in a track following mode and determining the amount of commanded current required to nominally maintain the head in this position. This allows the control circuit 132 to factor this bias value into account during subsequent operations.

Next, the head 112 is accelerated at step 206. This is preferably carried out in accordance with the curve 170 of FIG. 5 using a constant input value to achieve a constant rate of acceleration. During this continuous, increasing acceleration of the head 112, a plurality of distances successively traveled by the head at selected time samples are measured at step 208, e.g., the aforedescribed S(n−k), S(n) and S(n+k) values.

An inquiry is next made at decision step 210 to determine whether the routine is in a coarse mode or a fine mode. Generally, the coarse mode quickly converges the compensation value K_{A} to a first value near the final value, after which the fine mode allows further fine tuning of the K_{A} to the final value.

It is contemplated that both coarse mode and fine mode tuning will be performed during the device manufacturing process so that the device 100 leaves the factory with an initial, fully converged K_{A} value. Thereafter, the fine mode (and as desired, the coarse mode) can be used during field use at appropriate times, such as at power up, during idle periods, as significant temperature changes are detected during operation, etc., to continuously adapt K_{A} to match changes in the motor torque constant K_{T}.

Hence, the first time through the routine 200, the flow will start with the coarse mode and pass to step 212 wherein a variable K_{APREV}, or “K_{A} previous” is set equal to the then existing value of K_{A}. As mentioned above, this initial value may be set to one or some other suitable starting value the first time through the process. During subsequent executions of the routine 200, the K_{APREV} is preferably set to the most recently obtained value of K_{A}.

At step 214, an updated compensation value (denoted “K_{A}”) is determined in accordance with the following relations:
R=(W_{NOM})/(W_{MEAS})
K_{A}=(R)(K_{APREV}) (6)
The use of the values W_{NOM} and W_{MEAS} requires some explanation. While the X_{NOM} and X_{MEAS} values discussed above can be used in equation (6), it has been found advantageous to perform two (or more) seeks in opposite directions using the same control input level to further account for system variances such as bias forces. Accordingly, the values W_{NOM} and W_{MEAS} are preferably determined as follows:
W_{MEAS}=X_{MEAS1}+X_{MEAS2} (7)
Where X_{MEAS1} is the measured acceleration during a first seek in a first direction and X_{MEAS2} is the measured acceleration during a second seek in a second, opposite direction. Similarly,
W_{NOM}=2(X_{NOM}) (8)
It will be noted that the use of W_{NOM} and W_{MEAS} will generally require the aforementioned step 202 to include the calculation of W_{NOM} in accordance with equation (8), and the aforementioned steps 206 and 208 to be performed twice in succession to carry out the first and second seeks (in opposite directions). Indeed, any number of seek pairs can be performed and the results averaged if a higher population of measurement values is desired. Preferably, after each first seek the system maintains the head 112 in a track following mode to stabilize bias force compensation levels prior to the second seek.

The ratio R (i.e., W_{NOM}/W_{MEAS}) should converge to a value close to one as K_{A} approaches the final converged value. Hence, upon determining the updated compensation value during step 214, the flow continues to decision step 216 where the absolute magnitude of the value (R-1) is compared to a first threshold value Z₁.

If the compensation value is not sufficiently converged, the flow returns to step 206 and the previous steps are repeated. Once the most recently obtained compensation value K_{A} is found to have been sufficiently converged, the flow passes from decision step 216 to step 218 wherein the routine enters fine mode processing. It will be noted that during a subsequent execution of the routine 200 when fine mode adjustment is desired from the start, the flow will pass directly from decision step 210 to step 218 and the coarse mode processing will be skipped.

At step 220, a convergence rate factor α (ALPHA) is selected, preferably comprising a very small value close to zero. At step 222, an error term (ERR) is calculated in accordance with the following relationship:
ERR=W_{NOM}−W_{MEAS} (9)
and an updated compensation value K_{A} is obtained at step 224 using the following relationship:
K_{A}=K_{APREV}−(ALPHA)sign[ERR] (10)
The absolute value of the updated compensation value minus one (i.e., K_{A}−1) is next compared at decision step 226 to a second threshold value Z₂. It will be noted that steps 222 and 224 will continue to converge the value of K_{A} until a final value is reached, at which point the flow continues to step 228 where the final value is stored. As before, multiple pairs of seeks can be carried out and the results averaged for these steps, as desired. The routine then ends at step 230.

Thereafter, the compensation circuit 146 of FIG. 2 supplies the final compensation value K_{A} to the control circuit 134 to compensate for variations in motor torque until the next time that the routine 200 is executed.

The foregoing routine 200 has been found to provide advantages over the prior art. One such advantage is the fact that the routine 200 has been found to significantly reduce the time required to obtain final compensation values K_{A} for each zone. This can lead to significant throughput improvements in a high volume manufacturing process, and can also enable the routine 200 to be performed more frequently during field use of the device 100.

A related advantage is that because the routine employs an intelligent learning process, the time required to perform the compensation can be distributed more effectively; more time can be spent for some zones that require higher numbers of iterations, and time can be saved on other zones that require less iterations.

Another advantage is that the routine 200 can be readily applied to provide on-the-fly adaptation during operational seeks of the device 100. That is, provided that the acceleration of the head 112 is suitable for the taking of distance measurements (such as, for example, during model reference seeks that are less than full power), the compensation values can be continuously adjusted to account for changing environmental conditions (such as increases in temperature over extended operation).

Yet another advantage is that the routine 200 can further be used to characterize the value K_{T}/J, which is an important parameter relating to actuator/VCM response. An accurate determination of K_{T}/J, which can vary slightly from device to device, provides improved plant modeling in the control circuit 134. Once the value of X_{MEAS} is determined, the value K_{T}/J can be obtained by the following relation derived from equations (4) and (5) above:

$$\frac{{K}_{T}}{J} = [ \frac{{X}_{MEAS}}{( {k}^{2} ) ( {T}_{S}^{2} )} ] ( \frac{1}{( r ) ( TPI ) ( {U}_{DAC} ) ( {K}_{DAC} ) ( {K}_{P} )} ) \qquad ( 11 )$$

This value can be used, inter alia, to set the appropriate value of the power amplifier gain K_{P}.

Finally, another advantage of the routine 200 is that, generally, better matching of the final compensation values to the motor is obtained as compared to various prior art approaches. This is due in part to the intelligent learning approach, as well as due to the ability to minimize the effects of bias forces in the obtained measurements.

It will now be understood that the present invention, as embodied herein and as claimed below, is generally directed to an apparatus and method for compensating for motor torque variations in a control system (such as 130) that employs a motor (such as 114) to accelerate a control object (such as 112).

In one aspect, the method generally comprises using the motor to accelerate the control object (such as by step 206), and measuring a plurality of distances successively traveled by the control object during said acceleration to compensate for variation in motor torque (such as by step 206 and by steps 214, 224).

Preferably, a constant control input is applied to accelerate the control object at a constant rate of acceleration less than a maximum rate of acceleration that can be obtained by the motor (such as represented at 170). The control object is preferably maintained in a substantially fixed position to determine and compensate a magnitude of bias force upon the control object prior to acceleration of the motor (such as by step 204).

Preferably, a final compensation value (such as the value K_{A}) is determined by performing a coarse adjustment routine (such as by steps 210, 212, 214, 216) to arrive at a first compensation value that compensates for said variations in motor torque at a first resolution, and then performing a fine adjustment routine (such as by steps 218, 220, 222, 224, 226) using the first compensation value to arrive at the final compensation value at a second resolution greater than the first resolution.

In another aspect, the apparatus comprises a compensation circuit (such as 146) which measures a plurality of distances successively traveled by a control object (such as 112) during acceleration of said object by a motor (such as 114) to compensate for variation in motor torque.

The apparatus further preferably comprises a control circuit (such as 132) which applies an input to the motor (such as via path 134) to accelerate the control object, and wherein the compensation circuit determines a compensation value (such as the factor K_{A}) which is used by the control circuit to subsequently accelerate the control object.

Preferably, the motor accelerates the control object at a constant rate of acceleration less than a maximum rate of acceleration that can be obtained by the motor (such as by 170). Moreover, the control object is preferably maintained in a substantially fixed position to determine and compensate a magnitude of bias force upon the control object prior to acceleration of the motor (such as by step 204).

As before, a coarse adjustment routine is preferably performed followed by a fine adjustment routine to obtain the final compensation value.

For purposes of the appended claims, the recited first means will be understood to correspond to the compensation circuit 146 and the control circuit 132 in FIG. 2 which operate in accordance with the routine of FIG. 6.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

1. A method comprising using a motor to accelerate a control object, and measuring a plurality of distances successively traveled by the control object during said acceleration to compensate for variation in motor torque.

2. The method of claim 1, wherein the using step comprises applying a constant control input to accelerate the control object at a constant rate of acceleration less than a maximum rate of acceleration that can be obtained by the motor.

3. The method of claim 1, further comprising maintaining the control object in a substantially fixed position to determine a magnitude of bias force upon the control object prior to acceleration of the motor during the using step.

4. The method of claim 1, wherein the plurality of measured distances of the measuring step comprises three measured distances.

5. The method of claim 1, wherein the measuring step comprises combining the plurality of measured distances to obtain a measured acceleration of the control object.

6. The method of claim 4, wherein the measuring step further comprises combining the measured acceleration with a nominal acceleration of the control object to determine a compensation value.

7. The method of claim 1, wherein the compensation value of the measuring step comprises a gain adjustment factor.

8. The method of claim 7, further comprising a step of subsequently accelerating the control object using the gain adjustment factor.

9. The method of claim 1, wherein the control object accelerated during the using step comprises an actuator of a data storage device that supports a data transducing head adjacent a recording medium.

10. The method of claim 1, wherein the measuring step further comprises performing a coarse adjustment routine to arrive at a first compensation value that compensates for said variations in motor torque at a first resolution, and then performing a fine adjustment routine using the first compensation value to arrive at a final compensation value at a second resolution greater than the first resolution.

11. An apparatus comprising a compensation circuit which measures a plurality of distances successively traveled by a control object during acceleration of said object by a motor to compensate for variation in motor torque.

12. The apparatus of claim 11, further comprising a control circuit which applies an input to the motor to accelerate the control object, wherein the compensation circuit determines a compensation value which is used by the control circuit to subsequently accelerate the control object.

13. The apparatus of claim 11, wherein the motor accelerates the control object at a constant rate of acceleration less than a maximum rate of acceleration that can be obtained by the motor.

14. The apparatus of claim 11, further comprising maintaining the control object in a substantially fixed position to determine a magnitude of bias force upon the control object prior to acceleration of the motor.

15. The apparatus of claim 11, wherein the plurality of measured distances comprises three measured distances.

16. The apparatus of claim 15, wherein the compensation circuit combines the three measured distances to obtain a measured acceleration of the control object.

17. The apparatus of claim 16, wherein the compensation circuit further combines the measured acceleration with a nominal acceleration of the control object to determine the compensation value.

18. The apparatus of claim 11, wherein the control object comprises an actuator of a data storage device that supports a data transducing head adjacent a recording medium.

19. The apparatus of claim 11, wherein the compensation value comprises a final compensation value, and wherein the compensation circuit performs a coarse adjustment routine to arrive at a first compensation value that compensates for said variations in motor torque at a first resolution, and then performs a fine adjustment routine using the first compensation value to arrive at the final compensation value at a second resolution greater than the first resolution,

20. An apparatus, comprising:
a motor which accelerates a control object; and
first means for determining a compensation value to compensate for variation in motor torque in relation to a plurality of measured distances successfully traveled by the control object during said acceleration.
